(19) United States
(12) Patent Application Publication
(10) Pub. No.: US 2011/0058783 A1
(43) Pub. Date: Mar. 10, 2011

(54) FIBER OPTIC ENCLOSURE COVER

(76) Inventor: Hua li Wang, BinHai City (CN)

(21) Appl. No.: 12/714,161

(22) Filed: Feb. 26, 2010

Related U.S. Application Data
(63) Continuation of application No. 29/338,301, filed on Jun. 9, 2009, now Pat. No. D620898.

(51) Int. Cl. G02B 6/44

(52) U.S. Cl. 385/134

(57) ABSTRACT

A cover for a fiber optic enclosure includes a front wall, a back wall, a top wall and a right wall. The top wall is engaged with top end portions of the front and back walls. The right wall is engaged with right end portions of the front and back walls and a right end of the top wall. The right wall includes a lower portion and an upper portion. The upper portion is disposed at an oblique angle relative to the lower portion of the right wall. Inner surfaces of the front, back, top and right walls define a cavity. Bottom end portions of the front and back walls and the lower portion of the right wall define a first opening to the cavity. Left end portions of the front and back walls and a left end of the top wall defining a second opening to the cavity.

### CROSS REFERENCE TO RELATED APPLICATION

This application is a continuation of U.S. patent application Ser. No. 29/338,301, entitled “Fiber Optic Enclosure Cover” and filed on Jun. 9, 2009, the disclosure of which is hereby incorporated by reference in its entirety.

### BACKGROUND

The present application relates to a cover for a fiber optic enclosure.

### SUMMARY

An aspect of the present disclosure relates to a cover for a fiber optic enclosure. The cover includes a front wall, a back wall, a top wall and a right wall. The front wall has a top end portion, a bottom end portion, a right end portion and a left end portion. The front wall includes an outer surface and an inner surface. The back wall has a top end portion, a bottom end portion, a right end portion and a left end portion. The back wall includes an outer surface and an inner surface. The back wall is parallel to the front wall. The top wall is engaged with the top end portions of the front and back walls. The top wall has a right end and a left end. The top wall includes an outer surface and an inner surface. The right wall is engaged with the right end portions of the front and back walls and the right end of the top wall. The right wall includes an outer surface and an inner surface. The right wall includes a lower portion and an upper portion. The right wall includes a bend disposed between the lower and upper portions. The upper portion is disposed at an oblique angle relative to the lower portion of the right wall. The inner surfaces of the front, back, top and right walls define a cavity. The bottom end portions of the front and back walls and the lower portion of the right wall define a first opening to the cavity. The left end portions of the front and back walls and the left end of the top wall defining a second opening to the cavity.

Another aspect of the present disclosure relates to a cover for a fiber optic enclosure. The cover includes a first wall, a second wall and a third wall. The first wall has a first longitudinal end portion, an oppositely disposed second longitudinal end portion, a first axial end portion and an oppositely disposed second axial end portion. The second wall has a first longitudinal end portion, an oppositely disposed second longitudinal end portion, a first axial end portion and an oppositely disposed second axial end portion. The third wall has a first longitudinal end, an oppositely disposed second longitudinal end, a first axial end and an oppositely disposed second axial end. The first longitudinal end of the third wall is engaged with the first longitudinal end portion of the first wall and the second longitudinal end of the third wall is engaged with the first longitudinal end portion of the second wall. The cover includes a closed end. The closed end is engaged with the first axial end portions of the first and second walls and the first axial end of the third wall. The closed end has a first portion and a second portion. The second portion is disposed at an oblique angle relative to the first portion. The first, second and third walls and the closed end cooperatively define a cavity. The second longitudinal end portions of the first and second walls and the first portion of the closed end define a first opening to the cavity. The second axial end portions of the first and second walls and the second axial end of the third wall define a second opening to the cavity.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a perspective view of a fiber optic enclosure cover having exemplary features of aspects in accordance with the principles of the present disclosure.

FIG. 2 is a top view of the fiber optic enclosure cover of FIG. 1.

FIG. 3 is a bottom view of the fiber optic enclosure cover of FIG. 1.

FIG. 4 is a left side view of the fiber optic enclosure cover of FIG. 1.

FIG. 5 is a right side view of the fiber optic enclosure cover of FIG. 1.

FIG. 6 is a front view of the fiber optic enclosure cover of FIG. 1.

FIG. 7 is a back view of the fiber optic enclosure cover of FIG. 1.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

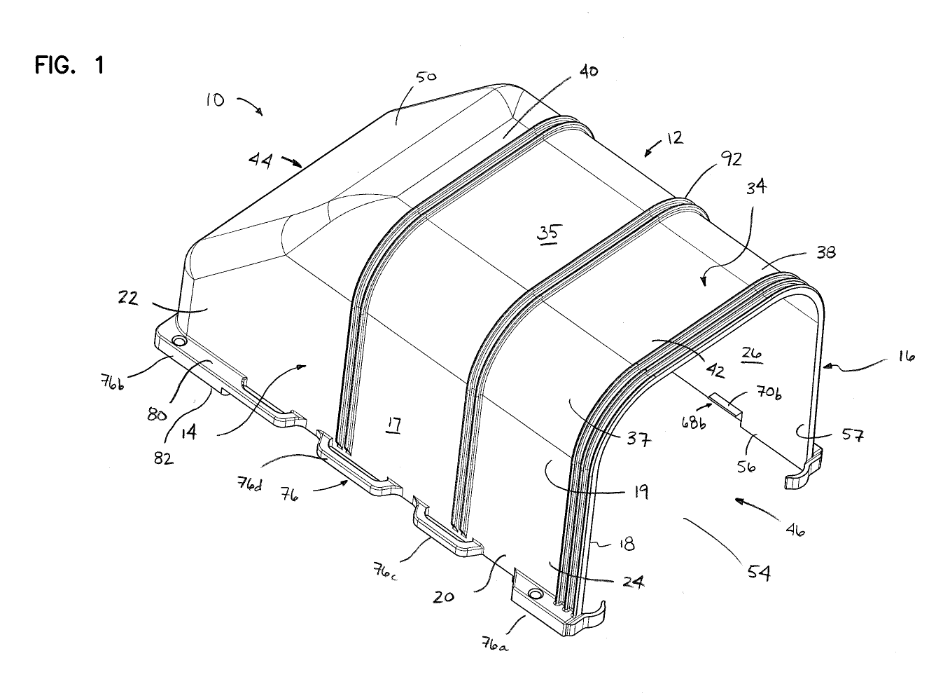

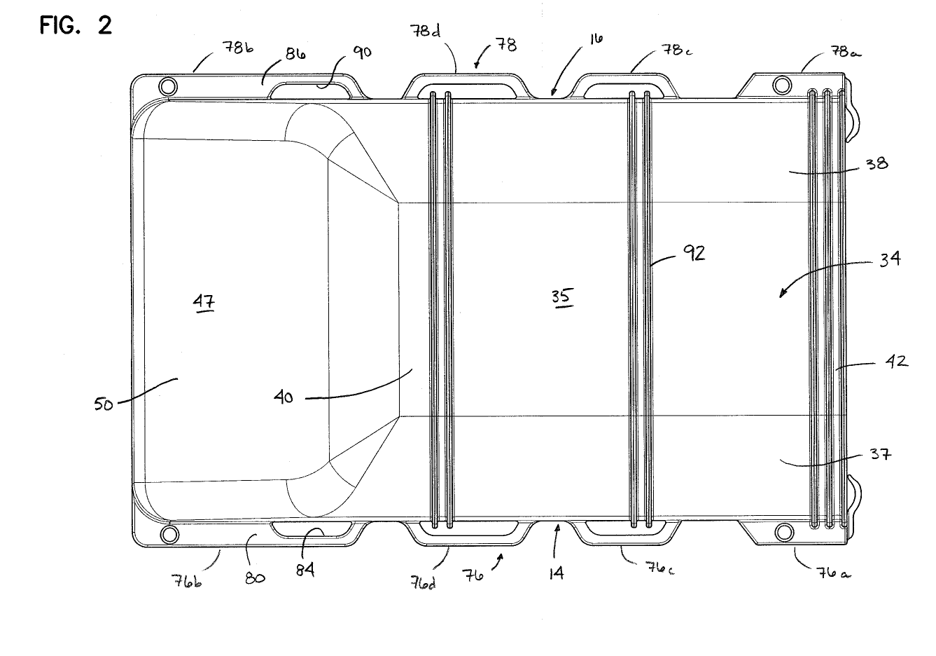

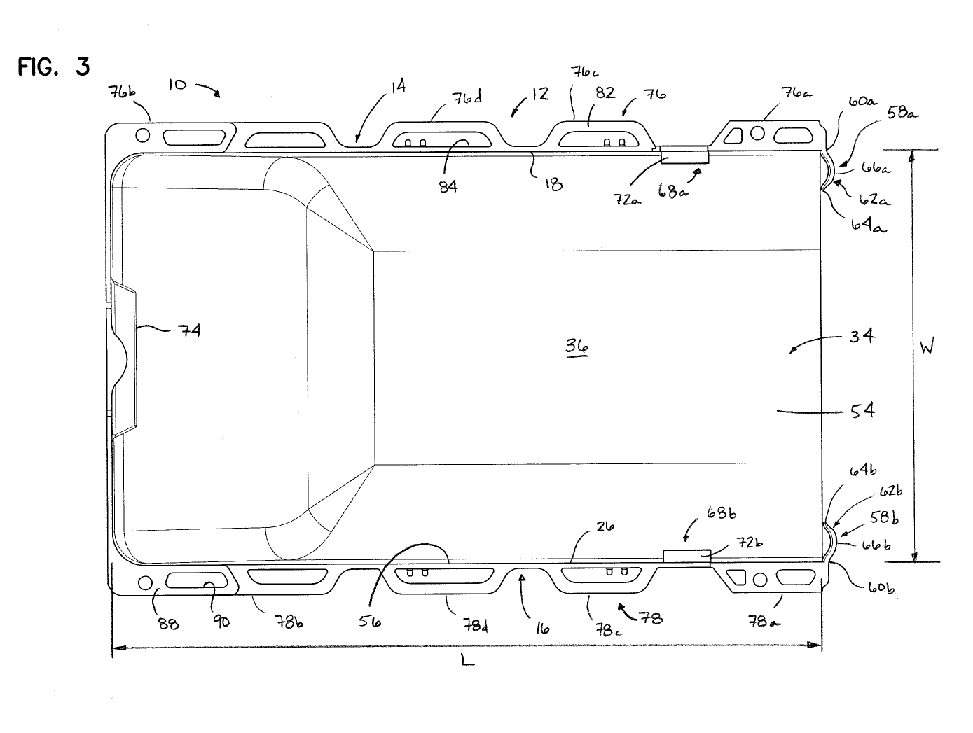

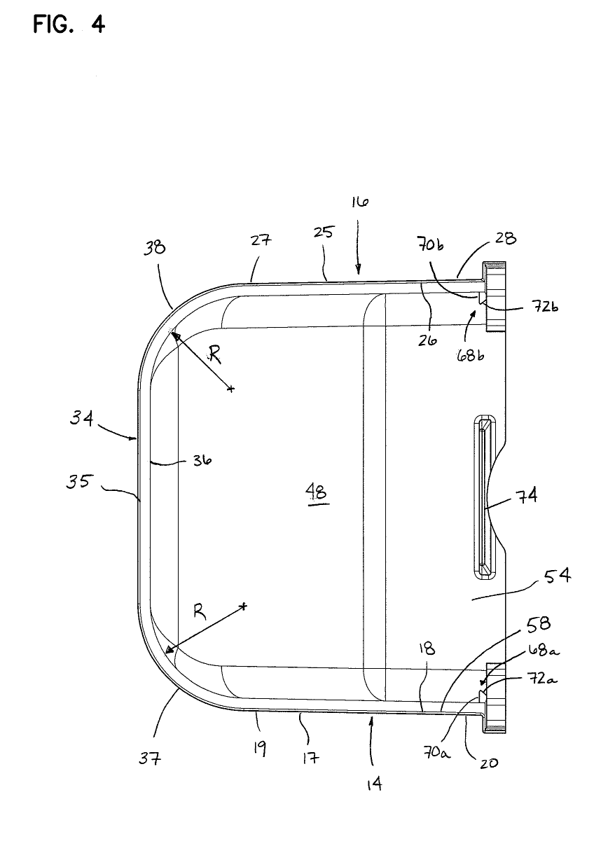

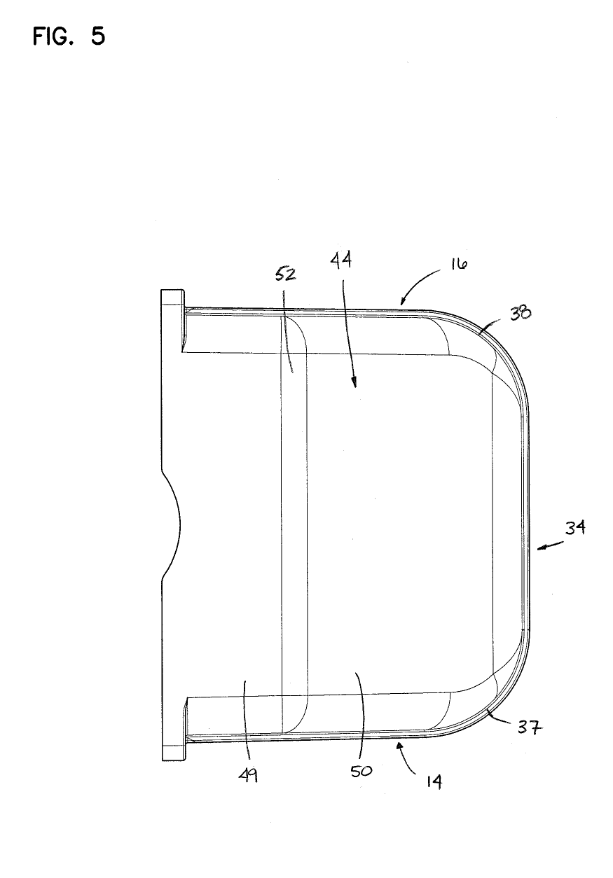

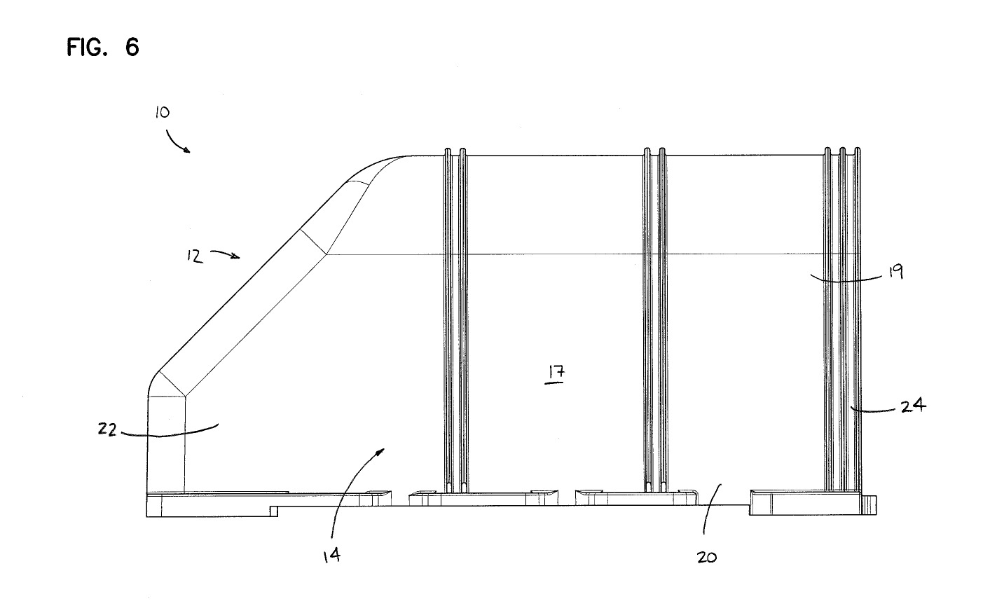

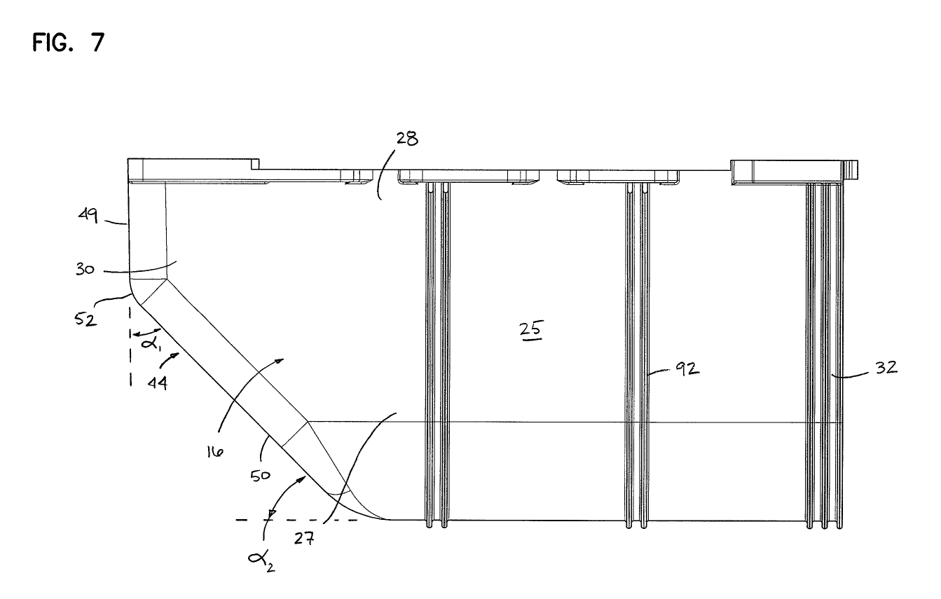

Referring now to FIGS. 1-7, a cover, generally designated 10, for a fiber optic enclosure is shown. The cover 10 includes a body 12.

The body 12 includes a first wall 14 and an oppositely disposed second wall 16. In the depicted orientation of FIGS. 1-7, the first wall 14 is a front wall while the second wall 16 is a back wall.

The first wall 14 includes an outer surface 17 and an inner surface 18. The first wall 14 has a first longitudinal end portion 19 and an oppositely disposed second longitudinal end portion 20. In the depicted orientation of FIGS. 1-7, the first longitudinal end portion 19 of the first wall 14 is a top end portion while the second longitudinal end portion 20 is a bottom end portion. The first wall 14 also has a first axial end portion 22 and an oppositely disposed second axial end portion 24. Each of the first and second axial end portions 22, 24 extends between the first and second longitudinal end portions 19, 20 of the first wall 14. In the depicted orientation of FIGS. 1-7, the first axial end portion 22 is a right end portion while the second axial end portion 24 is a left end portion.

The second wall 16 includes an outer surface 25 and an inner surface 26. The second wall 16 has a first longitudinal end portion 27 and an oppositely disposed second longitudinal end portion 28. In the depicted orientation of FIGS. 1-7, the first longitudinal end portion 27 of the second wall 16 is a top end portion while the second longitudinal end portion 28 is a bottom end portion. The second wall 16 also has a first axial end portion 30 and an oppositely disposed second axial end portion 32. Each of the first and second axial end portions 30, 32 extends between the first and second longitudinal end portions 27, 28 of the second wall 16. In the depicted orientation of FIGS. 1-7, the first axial end portion 30 is a right end portion while the second axial end portion 32 is a left end portion.

Spatially relative terms, such as “front,” “back,” “top,” “bottom,” “left,” “right,” etc., are used in the present disclosure to describe the spatial relationships between different features. The use of these spatially relative terms is for ease of description purposes only. It will be understood that the cover 10 can be used in orientations different from that shown in the figures. In these different orientations, the spatially relative terms will be interpreted in accordance with the orientation. For example, if the cover 10 were rotated 90 degrees in a counterclockwise direction, the front wall 14 would be positioned at a left side of the cover 10. If the cover 10 were rotated 180 degrees in a counterclockwise direction, the front wall 14 would be positioned at a back side of the cover 10. In these examples, the spatially relative term “front” would be interpreted accordingly.

The body 12 further includes a third wall 34. In the depicted orientation of FIGS. 1-7, the third wall 34 is a top wall. The third wall 34 includes an outer surface 35 and an inner surface 36. The third wall 34 further includes a first longitudinal end 37 and an oppositely disposed second longitudinal end 38. In the depicted orientation of FIGS. 1-7, the first longitudinal end 37 of the third wall 34 is a front longitudinal end while the second longitudinal end 38 is a back longitudinal end. Each of the first and second longitudinal ends 37, 38 of the third wall 34 is arcuate in shape and includes a radius R.

The third wall 34 further includes a first axial end 40 and an oppositely disposed second axial end 42. In the depicted orientation of FIGS. 1-7, the first axial end 40 is a right end while the second axial end 42 is a left end.

The third wall 34 extends between the first and second walls 14, 16 at the first longitudinal end portions 19, 27 of the first and second walls 14, 16. The third wall 34 is integral with the first and second wall 14, 16. The first longitudinal end 37 of the third wall 34 is monolithically connected (i.e., no joints, seams, welds etc.) to the first longitudinal end portion 19 of the first wall 14 while the second longitudinal end 38 of the third wall 34 is monolithically connected to the first longitudinal end portion 27 of the second wall 16.

The body 12 includes a first end 44 and an oppositely disposed second end 46. In the depicted orientation of FIGS. 1-7, the first end 44 is a right wall that is disposed on the right side of the body 12 while the second end 46 is disposed on the left side. The first end 44 is a closed end while the second end 46 is an open end.

The first end 44 extends between the first and second 14, 16 at the first axial end portions 22, 30 of the first and second walls 14, 16, respectively. The first end 44 is monolithically connected to the first axial end portions 22, 30 of the first and second walls 14, 16 and the first axial end 40 of the third wall 34.

The first end 44 includes an outer surface 47 and an inner surface 48. The first end 44 further includes a first portion 49 and a second portion 50. In the depicted orientation of FIGS. 1-7, the first portion 49 is a lower portion while the second portion 50 is an upper portion. A bend 52 is disposed between the first and second portions 49, 50 of the first end 44. The bend 52 extends along the first end 44 between the first axial end portions 22, 30 of the first and second walls 14, 16, respectively.

The second portion 50 of the first end 44 is disposed at a first oblique angle α₁ relative to the first portion 49. The second portion 50 of the first end 44 is disposed at a second oblique angle α₂ relative to the third wall 34.

The inner surfaces 18, 26, 36, 48 of the first, second and third walls 14, 16, 34 and the first end 44 cooperatively define a cavity 54. The second longitudinal end portions 20, 28 of the first and second walls 14, 16 and the first portion 49 of the first end 44 define a first opening 56 to the cavity 54 so that the inner surfaces 18, 26 of the second longitudinal end portions 20, 28 of the first and second walls 14, 16 and the inner surface 48 of the first portion 49 of the first end 44 define a perimeter of the first opening 56. The first opening 56 is disposed opposite the third wall 34. The first opening 56 extends a length L from the inner surface 48 of the first end 44 to the second end 46 of the body 12 and a width W from the inner surface 18 of the first wall 14 to the inner surface 26 of the second wall 16.

As previously provided, the second end 46 of the body 12 is an open end. The second axial end portions 24, 32 of the first and second walls 14, 16 and the second axial end 42 of the third wall 34 cooperatively define a second opening 57 that provides access to the cavity 54. The second opening 57 extends between the inner surfaces 18, 26, 36 of the first, second and third walls 14, 16, 34, respectively, so that the inner surfaces 18, 26, 36 of the second axial end portions 24, 32 of the first and second walls 14 and 16 and the inner surface 36 of the second axial end 42 of the third wall 34 define a perimeter of the second opening 57.

The first, second and third walls 14, 16, 34 and the first end 44 are continuous. It will be understood that the term “continuous” means that the first, second and third walls 14, 16, 34 and the first end 44 are uninterrupted so that there are no openings that extend through the outer and inner surfaces 17, 18, 25, 26, 35, 36, 47, 48 of the first, second and third walls 14, 16, 34 and the first end 44.

The body 12 further includes a first clip 58a and a second clip 58b. The first clip 58a is disposed on the body 12 at the second axial end portion 24 of the first wall 14 while the second clip 58b is disposed on the body 12 at the second axial end portion 32 of the second wall 16.

Each of the first and second clips 58a, 58b includes a base end 60a, 60b and a free end 62a, 62b. The base end 60a of the first clip 58a is mounted to second axial end portion 24 of the first wall 14 at a location that is adjacent to the second longitudinal end portion 20 of the first wall 14. The free end 62a of the first clip 58a extends in an outward direction from the inner surface 18 of the first wall 14 toward the inner surface 26 of the second wall 16. The free end 62a of the first clip 58a is generally arcuate in shape. The free end 62a includes an end 64a and a body portion 66a that extends between the base end 60a and the end 64a. The end 64a is generally aligned with the base end 60a. The body portion 66a curves outwardly from the second end 46.

The base end 60b of the second clip 58b is mounted to the second axial end portion 32 of the second wall 16 at a location that is adjacent to the second longitudinal end portion 28 of the second wall 16. The free end 62b of the second lip 58b extends in an outward direction from the inner surface 26 of the second wall 16 toward the inner surface 18 of the first wall 14. The free end 62b of the second clip 58b is generally arcuate in shape. The free end 62b includes an end 64b and a body portion 66b that extends between the base end 60b and the end 64b. The end 64b is generally aligned with the base end 60b. The body portion 66b curves outwardly from the second end 46.

The body 12 further includes a first latch 68a and a second latch 68b. The first latch 68a extends into the cavity 54 from the inner surface 18 of the first wall 14. The first latch 68a extends in a direction toward the inner surface 26 of the second wall 16. The second latch 68b extends into the cavity 54 from the inner surface 26 of the second wall 16. The second latch 68b extends in a direction toward the inner surface 18 of the first wall 14. The first latch 68a is disposed at an axial location that is nearer the second axial end portion 24 of the first wall 14 than the first axial end portion 22 of the first wall 14. The second latch 68b is disposed at an axial location that is nearer the second axial end portion 32 of the second wall 16 than the first axial end portion 30. The first latch 68a is axially aligned with the second latch 68b.

Each of the first and second latches 68a, 68b includes a lip 70a, 70b and an angled surface 72a, 72b. The lip 70a of the first latch 68a is perpendicular to the first wall 14 while the lip 70b of the second latch 68b is perpendicular to the second wall 16. The angled surface 72a of the first latch 68a extends at an oblique angle between the inner surface 18 of the first wall 14 and the lip 70a of the first latch 68a. The angled surface 72b of the second latch 68b extends at an oblique angle between the inner surface 26 of the second wall 16 and the lip 70b of the second latch 68b.

The body 12 further includes a projection 74 that extends into the cavity 54 from the inner surface 48 of the first end 44. The projection 74 extends into the cavity 54 from the inner surface 48 of the first portion 49 of the first end 44. The projection 74 is centrally disposed between the first and second walls 14, 16.

The body 12 further includes a first plurality of tabs 76 and a second plurality of tabs 78. The first plurality of tabs 76 is disposed on the outer surface 17 of the second longitudinal end portion 20 of the first wall 14 so that the first plurality of tabs 76 extend outwardly from the outer surface 17 of the second longitudinal end portion 20 of the first wall 14 in a generally perpendicular direction. The second plurality of tabs is disposed on the outer surface 25 of the second longitudinal end portion 28 of the second wall 16 so that the second plurality of tabs 78 extend outwardly from the outer surface 25 of the second longitudinal end portion 28 of the second wall 16 in a generally perpendicular direction.

The first plurality of tabs 76 includes a first tab 76a disposed at the first axial end portion 22 of the first wall 14 and a second tab 76b disposed at the second axial end portion 24 of the first wall 14. The first plurality of tabs 76 further includes a third tab 76c disposed between the first and second tabs 76a, 76b and a fourth tab 76d disposed between the second and third tabs 76b, 76c. Each of the first, second, third and fourth tabs 76a, 76b, 76c, 76d include a first surface 80 and an oppositely disposed second surface 82. The first surface 80 of each of the first plurality of tabs 76 faces in a first direction while the second surface 82 faces in a second direction that is opposite the first direction. In the depicted orientation of FIGS. 1-7, the first surface 80 is the top surface while the second surface 82 is the bottom surface. The second surfaces 82 of the first and second tabs 76a, 76b extend farther in the second direction than the second surfaces 82 of the third and fourth tabs 76c, 76d.

Each of the first plurality of tabs 76 defines a passage 84 that extends through the first and second surface 80, 82 of the respective tab 76. Each of the first, third and fourth tabs 76a, 76c, 76d includes one passage 84 while the second tab 76b include two passages 84.

The second plurality of tabs 78 includes a first tab 78a disposed at the first axial end portion 30 of the second wall 16 and a second tab 78b disposed at the second axial end portion 32 of the second wall 16. The second plurality of tabs 78 further includes a third tab 78c disposed between the first and second tabs 78a, 78b and a fourth tab 78d disposed between the second and third tabs 78b, 78c. Each of the first, second, third and fourth tabs 78a, 78b, 78c, 78d include a first surface 86 and an oppositely disposed second surface 88. The first surface 86 of each of the second plurality of tabs 78 faces in a first direction while the second surface 88 faces in a second direction that is opposite the first direction. In the depicted orientation of FIGS. 1-7, the first surface 86 is the top surface while the second surface 88 is the bottom surface. The second surfaces 88 of the first and second tabs 76a, 76b extend farther in the second direction than the second surfaces 88 of the third and fourth tabs 78c, 78d.

Each of the second plurality of tabs 78 defines a passage 90 that extends through the first and second surface 86, 88 of the respective tab 78. Each of the first, third and fourth tabs 78a, 78c, 78d includes one passage 90 while the second tab 78b includes two passages 90.

The body 12 further includes a plurality of ribs 92. Each of the ribs 92 extends from the second longitudinal end portion 20 (i.e., the bottom end portion) of the first wall 14 to the second longitudinal end portion 28 of the second wall 16 so that the rib 92 extends across each of the first, second and third walls 14, 16, 34. Each of the ribs 92 extends outwardly from the outer surfaces 17, 25, 35 of the first, second and third walls 14, 16, 34.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A cover for a fiber optic enclosure comprising:
a front wall having a top end portion, a bottom end portion, a right end portion and a left end portion, the front wall including an outer surface and an inner surface;
a back wall having a top end portion, a bottom end portion, a right end portion and a left end portion, the back wall including an outer surface and an inner surface, the back wall being parallel to the front wall;
a top wall engaged with the top end portions of the front and back walls, the top wall having a right end and a left end, the top wall including an outer surface and an inner surface;
a right wall being engaged with the right end portions of the front and back walls and the right end of the top wall, the right wall including an outer surface and an inner surface, the right wall including a lower portion and an upper portion, the right wall including a bend disposed between the lower and upper portions, the upper portion being disposed at an oblique angle relative to the lower portion of the right wall;
the inner surfaces of the front, back, top and right walls defining a cavity;
the bottom end portions of the front and back walls and the lower portion of the right wall defining a first opening to the cavity; and
the left end portions of the front and back walls and the left end of the top wall defining a second opening to the cavity.

2. The cover of claim 1, wherein the front wall includes a first plurality of tabs that extends outwardly from the outer surface of the bottom end portion of the front wall.

3. The cover of claim 2, wherein each of the first plurality of tabs includes a passage that extends through a top surface and a bottom surface of the tab.

4. The cover of claim 1, wherein the left end portion of the front wall includes a first clip and the left end portion of the back wall includes a second clip.

5. The cover of claim 4, wherein each of the first and second clips includes a base end and a free end, the base end of the first clip being engaged with the left end portion of the front wall, the base end of the second clip being engaged with the left end portion of the back wall, the free end of the first clip extending in a direction toward the inner surface of the back wall, the free end of the second clip extending in a direction toward the inner surface of the front wall.

6. The cover of claim 5, wherein the free end of each of the first and second clips includes a body portion that is arcuate in shape.

7. The cover of claim 1, wherein the inner surface of the front wall includes a first latch disposed at the bottom end portion of the front wall and the inner surface of the back wall includes a second latch disposed at the bottom end portion of the back wall, the first and second latches extending into the cavity.

8. The cover of claim 7, wherein each of the first and second latches includes a lip and an angled surface.

9. The cover of claim 1, wherein the inner surface of the right wall includes a protrusion that extends into the cavity from the lower portion of the right wall.

10. A cover for a fiber optic enclosure comprising:
a first wall having a first longitudinal end portion, an oppositely disposed second longitudinal end portion, a first axial end portion and an oppositely disposed second axial end portion;
a second wall having a first longitudinal end portion, an oppositely disposed second longitudinal end portion, a first axial end portion and an oppositely disposed second axial end portion;
a third wall having a first longitudinal end, an oppositely disposed second longitudinal end, a first axial end and an oppositely disposed second axial end, the first longitudinal end of the third wall being engaged with the first longitudinal end portion of the first wall and the second longitudinal end of the third wall being engaged with the first longitudinal end portion of the second wall;
a closed end being engaged with the first axial end portions of the first and second walls and the first axial end of the third wall, the closed end having a first portion and a second portion, the second portion being disposed at an oblique angle relative to the first portion;
the first, second and third walls and the closed end cooperatively defining a cavity;
the second longitudinal end portions of the first and second walls and the first portion of the closed end defining a first opening to the cavity; and
the second axial end portions of the first and second walls and the second axial end of the third wall defining a second opening to the cavity.

11. The cover of claim 1, wherein the front wall includes a first plurality of tabs that extends outwardly from the outer surface of the bottom end portion of the front wall.

12. The cover of claim 2, wherein each of the first plurality of tabs includes a passage that extends through a top surface and a bottom surface of the tab.

13. The cover of claim 1, wherein the left end portion of the front wall includes a first clip and the left end portion of the back wall includes a second clip.

14. The cover of claim 4, wherein each of the first and second clips includes a base end and a free end, the base end of the first clip being engaged with the left end portion of the front wall, the base end of the second clip being engaged with the left end portion of the back wall, the free end of the first clip extending in a direction toward the inner surface of the back wall, the free end of the second clip extending in a direction toward the inner surface of the front wall.

15. The cover of claim 5, wherein the free end of each of the first and second clips includes a body portion that is arcuate in shape.

16. The cover of claim 1, wherein the inner surface of the front wall includes a first latch disposed at the bottom end portion of the front wall and the inner surface of the back wall includes a second latch disposed at the bottom end portion of the back wall, the first and second latches extending into the cavity.

17. The cover of claim 7, wherein each of the first and second latches includes a lip and an angled surface.

18. The cover of claim 1, wherein the inner surface of the right wall includes a protrusion that extends into the cavity from the lower portion of the right wall.
